(19) United States
(12) Patent Application Publication
(10) Pub. No.: US 2012/0233872 A1
(43) Pub. Date: Sep. 20, 2012

(54) Apparatus for Treating a Bed of Particulate Material

(75) Inventor: Per Petersen, Holbaek (DK)

(73) Assignee: FLSMIDTH A/S, Valby (DK)

(21) Appl. No.: 13/511,277

(22) PCT Filed: Nov. 9, 2010
(86) PCT No.: PCT/IB10/55091

§ 371 Date: May 22, 2012

(30) Foreign Application Priority Data
Nov. 25, 2009 (DK) PA 2009 01244

(51) Int. Cl. F26B 19/00

(52) U.S. Cl. 34/90

(57) ABSTRACT

A description is given of an apparatus (1) for treating a bed (2) of particulate material which is supported by an aeration bottom (3), subject to the application of a conditioning gas being directed to and flowing up through the aeration bottom (3) and the material bed (2) from an underlying compartment (4) which comprises side walls (5), end walls (6) and a bottom (7). The apparatus is peculiar in that it comprises a space (8) for inspection which extends into the compartment (4) from one of its side walls (5), end walls (6) or bottom (7) and allowing access for a person for visual inspection by direct sight of the compartment (4) through a number of inspection openings (9).

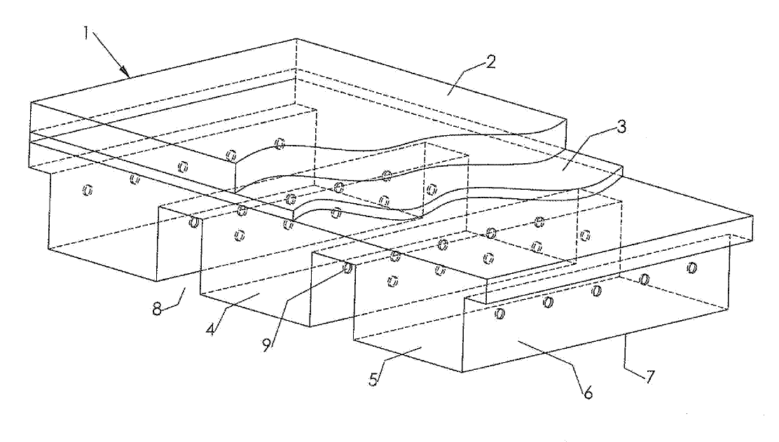

Hence it will be possible during the operation of the apparatus to inspect by direct sight the equipment in a significantly extended area of the compartment. This is due to the fact that the space for inspection makes it possible to inspect equipment located in areas of the compartment which are not visible due to poor visibility from windows located in the side walls of the compartment.

The present invention relates to an apparatus for treating a bed of particulate material which is supported by an aeration bottom, subject to the application of a conditioning gas being directed to and flowing up through the aeration bottom and the material bed from an underlying compartment which comprises side walls, end walls and a bottom.

In the industrial sector there are numerous examples of apparatuses featuring an aeration bottom. Non-limiting examples hereof include fluidized bed reactors, chemical reactors, drying devices, gas-solids heat exchangers inter alia. It is a common characteristic of these apparatuses that they may comprise in the compartment under the aeration bottom various equipment which is not immediately accessible or visible during operation. Such equipment may for example comprise flow regulators for sectionalized regulation of the gas flow as described in EP0848646, driving means, hydraulic components etc. During the start-up as well as the operation of the aforementioned apparatuses, it may be desirable to make a visual inspection of the equipment which is located in the compartment under the aeration bottom, and for this purpose known apparatuses feature a number of windows being located in the side walls of the compartment. However, the visibility in the compartment will often be restricted due to dust formations or similar phenomena and in such cases only the equipment in immediate proximity of the inspection windows can be visually inspected from the outside.

It is the objective of the present invention to provide an apparatus for treating a bed of particulate material whereby the aforementioned disadvantage is eliminated or at least significantly reduced.

According to the present invention this is achieved by an apparatus of the kind mentioned in the introduction, and being characterized in that it comprises a space for inspection which extends into the compartment from one of its side walls, end walls or bottom and allowing access for a person for visual inspection by direct sight of the compartment through a number of inspection openings.

Hence it will be possible during the operation of the apparatus to inspect by direct sight the equipment in a significantly extended area of the compartment. This is due to the fact that the space for inspection makes it possible to inspect equipment located in areas of the compartment which are not visible due to poor visibility from windows located in the side walls of the compartment.

The space for inspection may in principle have any suitable form which makes it possible to perform inspections at a deeper location inside the compartment. It may thus be oriented crosswise or lengthwise in relation to the longitudinal direction of the apparatus or vertically up from the bottom, where in the latter case access must be provided to the space, possibly by means of a tunnel. The space for inspection may extend somewhat inwards into the compartment or it may be through-going, thus forming a channel and extend across the entire width and length, respectively, of the apparatus. The space for inspection may furthermore be sized for accommodating a person, completely or partially.

In a preferred embodiment the space for inspection is formed as a through-going space forming a channel allowing a person to pass through, completely or partially. It is further preferred that such channel is transverse.

The invention will now be described in further details with reference to the drawing, being diagrammatical, and showing a clinker cooler with spaces for inspection in accordance with the invention.

The drawing shows a sectional view of a clinker cooler 1 for cooling a bed 2 of cement clinker which is supported by an aeration bottom 3, subject to the application of cooling gases being directed to and flowing up through the aeration bottom 3 and the clinker bed 2 from an underlying compartment 4 which comprises side walls 5, end walls 6 and a bottom 7.

In order to make it possible during the operation of the clinker cooler 1 to inspect equipment such as flow regulators, driving means, hydraulic components etc., not shown, being located in areas of the compartment 4 which will not be visible due to poor visibility from windows located in the side walls of the compartment, the shown clinker cooler 1 according to the invention comprises a number of through-going space 8 for inspection forming channels 8 extending through the compartment 4 from its one side wall 5 to the other, and being provided with inspection openings 9.

1. An apparatus (1) for treating a bed (2) of particulate material which is supported by an aeration bottom (3), subject to the application of a conditioning gas being directed to and flowing up through the aeration bottom (3) and the material bed (2) from an underlying compartment (4) which comprises side walls (5), end walls (6) and a bottom (7), being characterized in that it comprises a space (8) for inspection which extends into the compartment (4) from one of its side walls (5), end walls (6) or bottom (7) and allowing access for a person for visual inspection by direct sight of the compartment (4) through a number of inspection openings (9).

2. An apparatus according to claim 1, being characterized in that the space (8) for inspection is formed as a through-going space forming a channel allowing complete passage by a person.

3. An apparatus according to claim 1, being characterized in that the space (8) for inspection is formed as a through-going space forming a channel allowing partial passage by a person.

4. An apparatus according to claim 2 or 3, being characterized in that the channel (8) is transversely arranged.
